(19) United States
(12) Patent Application Publication
(10) Pub. No.: US 2026/0112836 A1
(43) Pub. Date: Apr. 23, 2026

(54) ELECTRICAL CONNECTION ASSEMBLY WITH CONDUCTIVE FILM

(71) Applicant: DONGGUAN LUXSHARE TECHNOLOGIES CO., LTD, Dongguan City (CN)

(72) Inventors: Kunlin YAO, Dongguan City (CN); Ruoyi ZHANG, Dongguan City (CN)

(73) Assignee: DONGGUAN LUXSHARE TECHNOLOGIES CO., LTD, Dongguan City (CN)

(21) Appl. No.: 18/930,579

(22) Filed: Oct. 29, 2024

(30) Foreign Application Priority Data
Oct. 22, 2024 (CN) 202411480922.7

(51) Int. Cl. H01R 13/24; H01R 12/70; H01R 12/79; H01R 13/50; H01R 13/621; H01R 13/6588

(52) U.S. Cl. CPC H01R 13/2414; H01R 12/7047; H01R 12/79; H01R 13/50; H01R 13/6215; H01R 13/6588

(57) ABSTRACT

An electrical connection assembly includes a connection module, a conductive film and a chip. The connection module includes a housing and a number of conductive elements. The housing is provided with a mounting wall, and the conductive elements are exposed to the mounting wall. The conductive film includes a skeleton, an elastomer fixed to the skeleton, and a number of transfer conductive elements embedded in the elastomer. The chip is provided with a number of conductive portions. The conductive film is sandwiched between the mounting wall and the chip. The conductive elements are electrically connected to the conductive portions through the transfer conductive elements.

### CROSS-REFERENCE TO RELATED APPLICATION

This patent application claims priority of a Chinese Patent Application No. 202411480922.7, filed on Oct. 22, 2024 and titled “ELECTRICAL CONNECTION ASSEMBLY”, the entire content of which is incorporated herein by reference.

### TECHNICAL FIELD

The present disclosure relates to an electrical connection assembly, which belongs to the technical field of electrical connection.

### BACKGROUND

Electrical connection assemblies in the related art generally include a printed circuit board, a chip mounted to the printed circuit board, a plurality of socket connectors mounted to the printed circuit board, and a plurality of plug connectors at least partially received in the socket connectors. Each socket connector includes a plurality of socket conductive terminals. Each plug connector includes a plurality of plug conductive terminals. The plug conductive terminals mate with the socket conductive terminals so that the plug connector is electrically connected to the chip through the socket connector and the printed circuit board.

However, with the continuous improvement of signal transmission requirements, the electrical connection assemblies that use printed circuit boards as media require the use of conductive traces on the printed circuit board as signal transmission channels, so the signal loss is relatively large, and the signal transmission rate the signal transmission quality need to be further improved. Besides, the electrical connection assemblies using printed circuit boards as media take up a large volume and cause a lot of inconvenience to the layout of the socket connectors.

### SUMMARY

An object of the present disclosure is to provide an electrical connection assembly with a conductive film to shorten the conductive path and improve the quality of signal transmission.

In order to achieve the above object, the present disclosure adopts the following technical solution: an electrical connection assembly, including: a connection module, the connection module including a housing and a plurality of conductive elements, the housing including a mounting wall, and the conductive elements being exposed to the mounting wall; a conductive film, the conductive film including a skeleton, an elastomer fixed to the skeleton and a plurality of transfer conductive elements embedded in the elastomer; and a chip, the chip including a plurality of conductive portions; wherein the conductive film is sandwiched between the mounting wall and the chip; the conductive elements are electrically connected to the conductive portions of the chip through the transfer conductive elements.

In order to achieve the above object, the present disclosure adopts the following technical solution: an electrical connection assembly, including: a connection module, the connection module including a housing and a plurality of conductive elements, the housing including a mounting wall having a mating surface, each conductive element including a rigid first contact portion extending beyond the mating surface; a conductive film, the conductive film including an elastomer and a plurality of transfer conductive elements fixed in the elastomer; the rigid first contact portions being in contact with the transfer conductive elements; a chip, the chip including a plurality of conductive portions; the transfer conductive elements being in contact with the conductive portions; and a retaining cover, the retaining cover being mounted to the housing to retain the chip between the mounting wall and the retaining cover; wherein the conductive film is sandwiched between the mounting wall and the chip; the conductive elements are electrically connected to the conductive portions of the chip through the transfer conductive elements.

Compared with the prior art, the electrical connection assembly of the present disclosure includes the connection module, the conductive film and the chip. The conductive film is sandwiched between the mounting wall and the chip. The elastomer is pressed and elastically deformed. The conductive elements are electrically connected to the chip through the transfer conductive elements. With this arrangement, the present disclosure shortens the conductive path, which is beneficial to improving the quality of signal transmission.

### BRIEF DESCRIPTION OF DRAWINGS

FIG. 1 is a perspective schematic view of an electrical connection assembly in accordance with an embodiment of the present disclosure;

FIG. 2 is a perspective view of FIG. 1 from another angle;

FIG. 3 is a right view of FIG. 1;

FIG. 4 is a top view of FIG. 1;

FIG. 5 is a bottom view of FIG. 1;

FIG. 6 is a partially exploded perspective view of the electrical connection assembly of the present disclosure;

FIG. 7 is an exploded perspective view of FIG. 6 from another angle;

FIG. 8 is a further perspective exploded view after removing a chip, a retaining cover and a plurality of fasteners in FIG. 6, in which a conductive film is separated;

FIG. 9 is a partial enlarged view of circled part A in FIG. 8;

FIG. 10 is a partially exploded perspective view of FIG. 8 from another angle;

FIG. 11 is a perspective exploded view of the conductive film;

FIG. 12 is a partially exploded perspective view of a connection module;

FIG. 13 is a partially exploded perspective view of a cable module of the connection module;

FIG. 14 is a further exploded perspective view of FIG. 13;

FIG. 15 is an exploded perspective view of FIG. 14 from another angle;

FIG. 16 is a schematic cross-sectional view taken along line B-B in FIG. 4; and

FIG. 17 is a partially enlarged view of frame portion C in FIG. 16.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

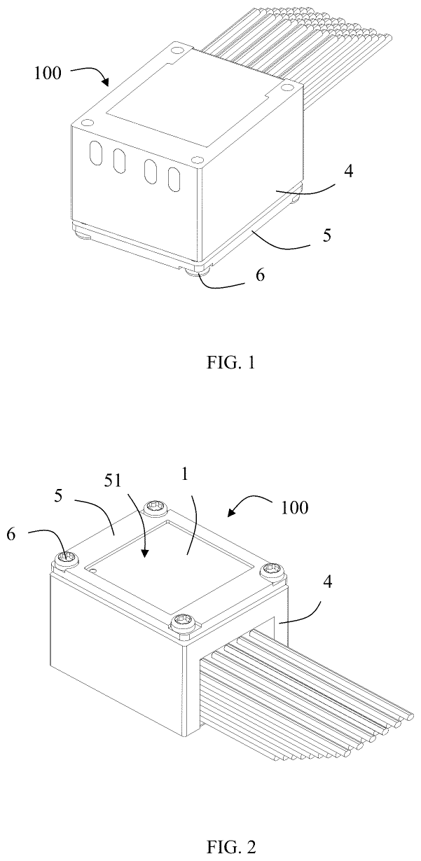

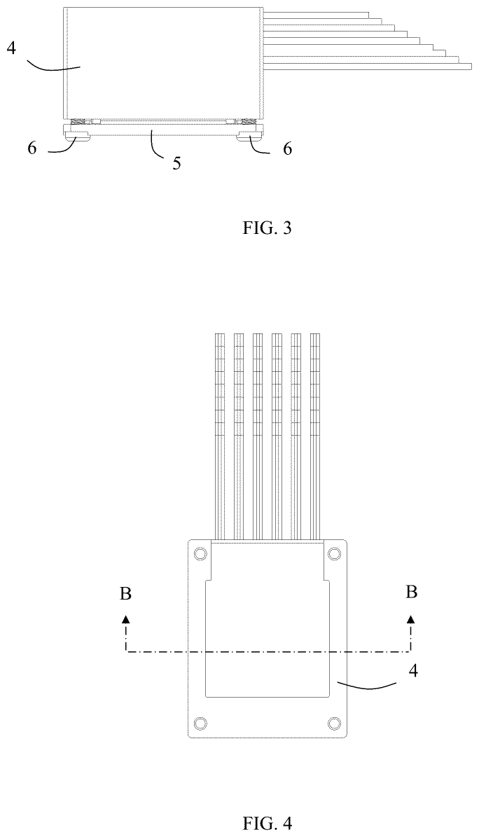

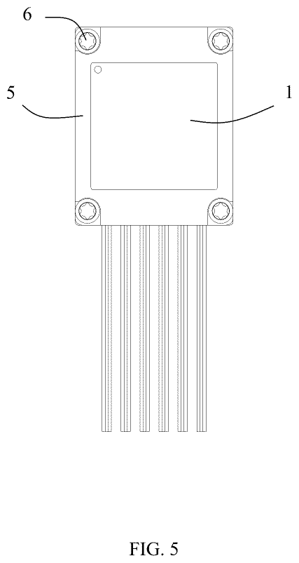

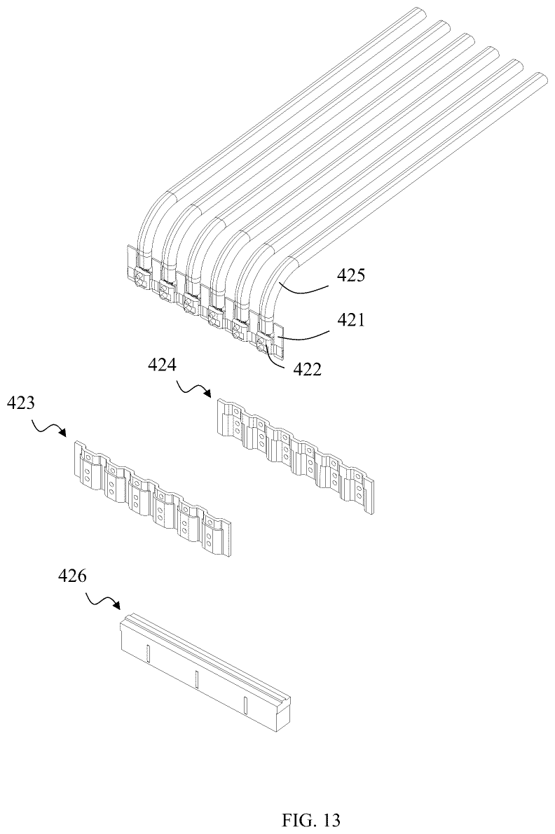

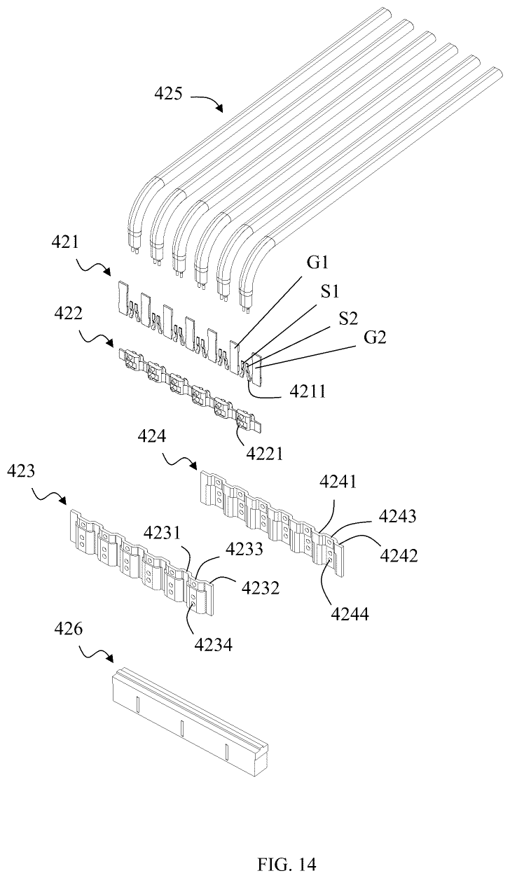

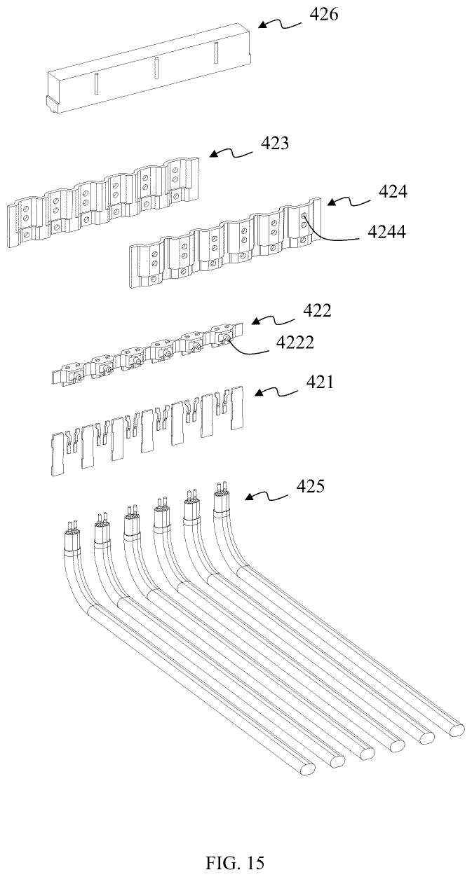

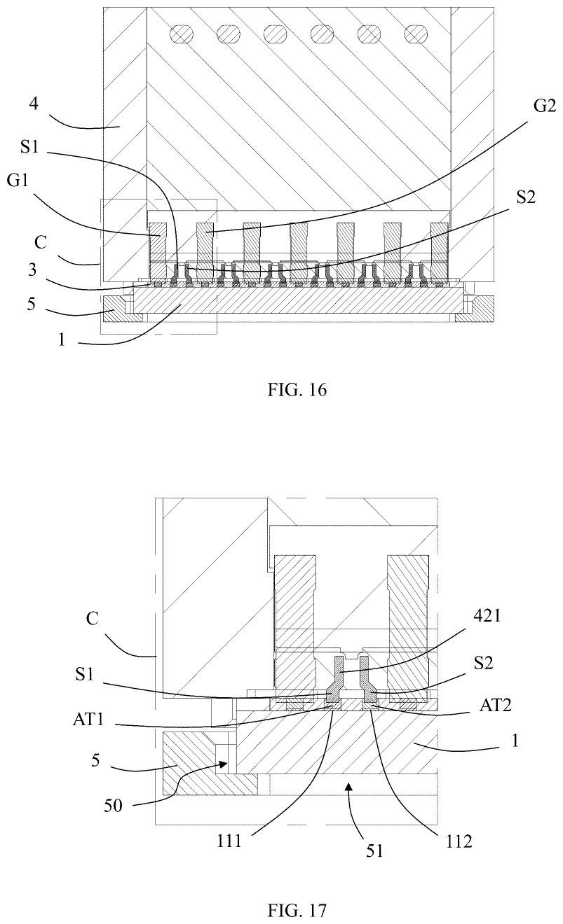

Referring to FIG. 1 to FIG. 17, the illustrated embodiment of the present disclosure discloses an electrical connection assembly 100, which includes a chip 1, a connection module 4, a conductive film 3 located between the chip 1 and the connection module 4, and a retaining cover 5 for holding the chip 1 in the mounting position. In the illustrated embodiment of the present disclosure, the connection module 4 is electrically connected to the chip 1 through the conductive film 3.

The connection module 4 includes a housing 41, a plurality of cable modules 42 and a fixing block 43 fixed on the cable modules 42. In one embodiment of the present disclosure, the fixing block 43 is made of insulating material, and is over-molded on the cable modules 42 to be integrated as a whole.

Referring to FIG. 8, in the illustrated embodiment of the present disclosure, the housing 41 includes a mounting wall 411 located at a bottom thereof. The mounting wall 411 includes a mating surface 4111, a plurality of positioning posts 4112 protruding downwardly from the mating surface 4111, and a plurality of positioning portions 4113 protruding downwardly from the mating surface 4111. In the illustrated embodiment of the present disclosure, two positioning posts 4112 are provided and arranged diagonally to improve the positioning accuracy. The positioning portions 4113 are located at four corners of the mounting wall 411 to hold the edges of the conductive film 3. In the illustrated embodiment of the present disclosure, the positioning portions 4113 form an accommodation space 4110. The mating surface 4111 is exposed to the accommodation space 4110. The chip 1 is at least partially accommodated in the accommodation space 4110.

As shown in FIG. 12 to FIG. 15, each cable module 42 includes a plurality of conductive elements 421, a first insulating block 422 fixed on the conductive elements 421, a first metal shielding piece 423 installed on one side of the first insulating block 422, a second metal shielding piece 424 installed on another side of the first insulating block 422, a plurality of cables 425 connected to the conductive elements 421, and a second insulating block 426 formed on the first metal shielding piece 423, the second metal shielding piece 424, the first insulating block 422 and the cables 425.

In the illustrated embodiment of the present disclosure, the conductive elements 421 include a first signal conductive terminal S1, a second signal conductive terminal S2, a first ground conductive terminal G1 and a second ground conductive terminal G2. The first signal conductive terminal S1 and the second signal conductive terminal S2 form a first signal differential pair DP1 to increase the signal transmission rate. The first ground conductive terminal G1 and the second ground conductive terminal G2 are located on two sides of the first signal differential pair DP1, respectively, to improve the quality of signal transmission. The cable 425 is connected to the first signal conductive terminal S1 and the second signal conductive terminal S2. In the illustrated embodiment of the present disclosure, the width and height of the first ground conductive terminal G1 are respectively greater than the width and height of the first signal conductive terminal S1. The width and height of the first ground conductive terminal G1 are respectively greater than the width and height of the second signal conductive terminal S2. The width and height of the second ground conductive terminal G2 are respectively greater than the width and height of the first signal conductive terminal S1. The width and height of the second ground conductive terminal G2 are respectively greater than the width and height of the second signal conductive terminal S2. Each conductive element 421 includes a non-elastic first contact portion 4211. In the illustrated embodiment of the present disclosure, the first contact portion 4211 is of a flat strip shape configuration.

In the illustrated embodiment of the present disclosure, the first insulating block 422 is formed on the conductive elements 421 to be integral with the conductive elements 421. The first contact portion 4211 of each conductive element 421 extends downwardly and protrudes beyond the first insulating block 422. The first insulating block 422 includes a first protruding post 4221 on one side of the first insulating block 422 and a second protruding post 4222 provided on another side of the first insulating block 422. The first ground conductive terminal G1 and the second ground conductive terminal G2 both extend upwardly beyond the first insulating block 422.

In the illustrated embodiment of the present disclosure, the first metal shielding piece 423 is generally of a wavy shape configuration, and includes a first abutting portion 4231, a second abutting portion 4232, and a first raised portion 4233 connected between the first abutting portion 4231 and the second abutting portion 4232.

Similarly, the second metal shielding piece 424 is generally of a wavy shaped configuration, and includes a third contact portion 4241, a fourth contact portion 4242, and a second raised portion 4243 connected between the third contact portion 4241 and the fourth contact portion 4242. The first raised portion 4233 and the second raised portion 4243 have opposite raised directions. The first raised portion 4233 defines a first positioning hole 4234 that receives the first protruding post 4221. The second raised portion 4243 defines a second positioning hole 4244 that receives the second protruding post 4222.

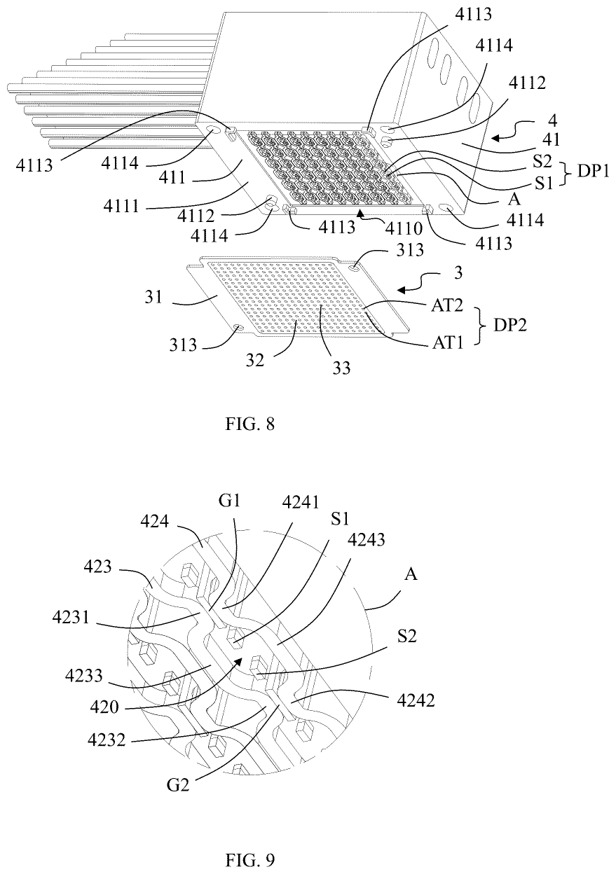

Referring to FIG. 9, in the illustrated embodiment of the present disclosure, the first abutting portion 4231 and the third contact portion 4241 are in contact with opposite side surfaces of the first ground conductive terminal G1, respectively. The second abutting portion 4232 and the fourth contact portion 4242 are in contact with two opposite side surfaces of the second ground conductive terminal G2, respectively. The first abutting portion 4231, the first raised portion 4233, the second abutting portion 4232, the second ground conductive terminal G2, the fourth contact portion 4242, and the second raised portion 4243, the third contact portion 4241 and the first ground conductive terminal G1 together form a shielding cavity 420. The first signal conductive terminal S1 and the second signal conductive terminal S2 are at least partially resides in the shielding cavity 420 to improve the quality of signal transmission.

Referring to FIG. 8 and FIG. 9, in the illustrated embodiment of the present disclosure, the shielding cavity 420 is exposed to the mounting wall 411. The first contact portion 4211 of the first signal conductive terminal S1, the first contact portion 4211 of the second signal conductive terminal S2, the first contact portion 4211 of the first ground conductive terminal G1, the first contact portion 4211 of the second ground conductive terminal G2, the first metal shielding piece 423, and the second metal shielding piece 424 all extend downwardly beyond the mating surface 4111.

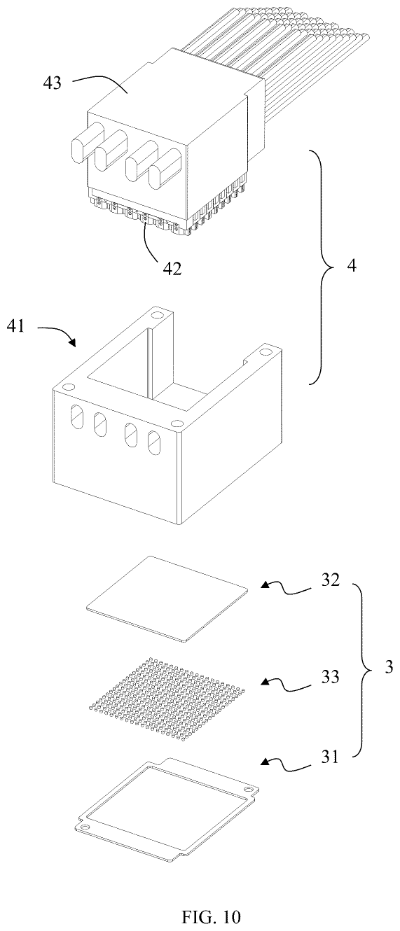

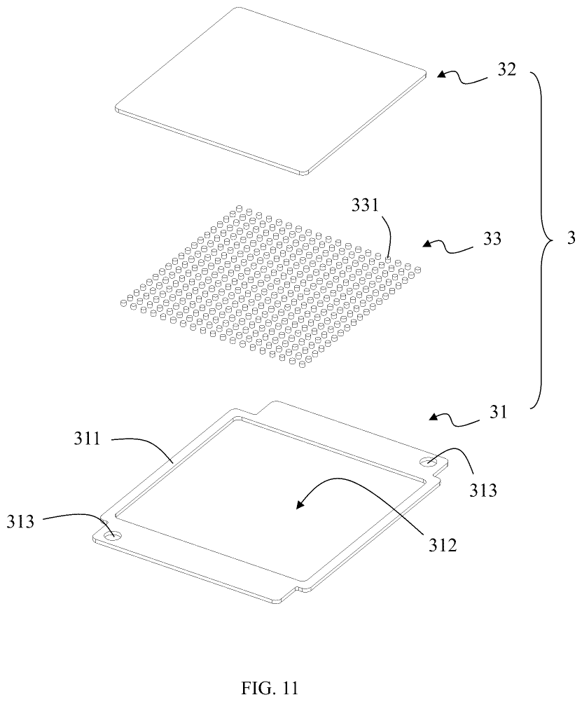

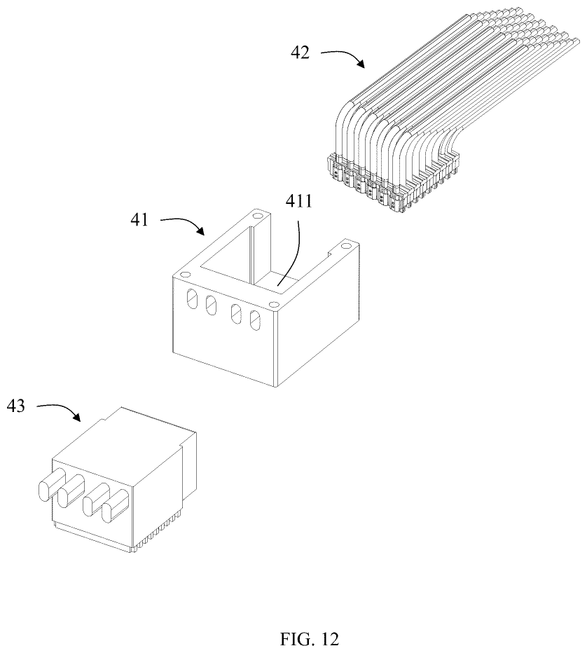

Referring to FIG. 8, FIG. 10 and FIG. 11, in the illustrated embodiment of the present disclosure, the conductive film 3 includes a skeleton 31, an elastomer 32 fixed to the skeleton 31, and a plurality of transfer conductive elements 33 embedded in the elastomer 32. In one embodiment of the present disclosure, the skeleton 31 is a metal base plate (for example, a steel frame structure) to provide better structural strength. The skeleton 31 is provided with a surrounding frame 311 and a filling space 312 located within the frame 311. The surrounding frame 311 is beneficial to ensuring the structural strength.

In one embodiment of the present disclosure, the elastomer 32 is a silicone elastomer. That is, the elastomer 32 is made of silicone, so that it has a certain elastic deformation ability. The elastomer 32 is filled in the filling space 312 to be fixed with the frame 31. It is understandable to those skilled in the art that the elastomer 32 will undergo compression deformation due to an external force, which is beneficial to absorbing the flatness error of the contact components.

Each transfer conductive element 33 includes transfer contact portions 331 respectively located at its upper and lower ends. The transfer conductive elements 33 include a first transfer terminal AT1 and a second transfer terminal AT2. The first transfer terminal AT1 and the second transfer terminal AT2 form a second signal differential pair DP2 to improve the quality of signal transmission.

In the illustrated embodiment of the present disclosure, the skeleton 31 of the conductive film 3 defines a plurality of first positioning through holes 313 to mate with the positioning posts 4112.

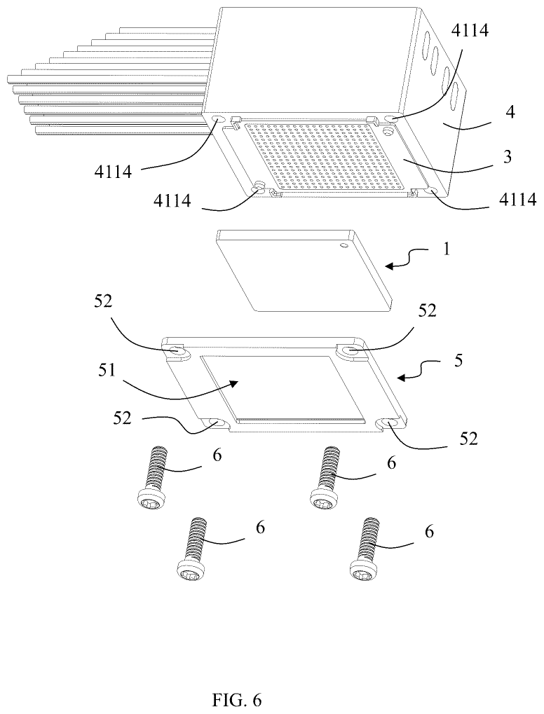

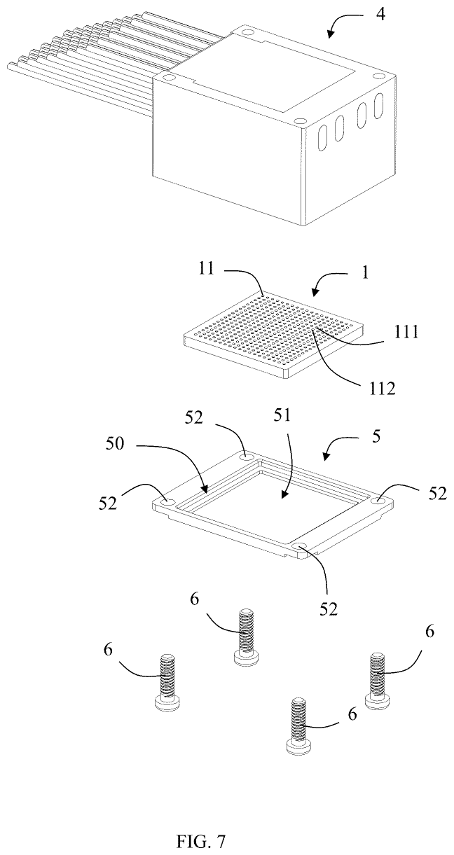

As shown in FIG. 6 and FIG. 7, the chip 1 (including but not limited to a central processing unit, CPU) is provided with a plurality of conductive portions 11. The conductive portions 11 are exposed on at least one side surface (for example, an upper surface) thereof to be in contact with the transfer conductive elements 33. The conductive portions 11 include a first conductive portion 111 and a second conductive portion 112.

It is understandable to those skilled in the art that the connection module 4, the conductive film 3 and the chip 1 of the present disclosure are connected in sequence. The conductive film 3 is sandwiched between the mounting wall 411 and the chip 1. The elastomer 32 is pressed to absorb the flatness error of the contact components. The conductive elements 421 are electrically connected to the chip 1 through the transfer conductive elements 33. Specifically, in the illustrated embodiment of the present disclosure, the first transfer terminal AT1 connects the first signal conductive terminal S1 and the first conductive portion 111. The second transfer terminal AT2 connects the second signal conductive terminal S2 and the second conductive portion 112.

The retaining cover 5 is mounted to the housing 41 to hold the chip 1 between the mounting wall 411 and the retaining cover 5.

Specifically, the retaining cover 5 includes a receiving groove 50, and an opening 51 extending through the retaining cover 5 and communicating with the receiving groove 50. The chip 1 is at least partially received in the receiving groove 50 and exposed to the opening 51 to improve heat dissipation.

The electrical connection assembly 100 further includes a plurality of fasteners 6 (for example, screws) passing through the retaining cover 5 to fix the retaining cover 5 to the mounting wall 411. Specifically, the retaining cover 5 defines a plurality of first through holes 52. The first through holes 52 are distributed at four corners of the retaining cover 5. The mounting wall 411 defines a plurality of second through holes 4114. The first through holes 52 corresponds to the second through holes 4114. The fastener 6 passes through the first through hole 52 and at least partially extends into the second through hole 4114 to be fixed in the mounting wall 411.

Compared with the prior art, the electrical connection assembly 100 of the present disclosure includes the connection module 4, the conductive film 3 and the chip 1. The conductive film 3 is sandwiched between the mounting wall 411 and the chip 1. The elastomer 32 is pressed. The conductive elements 421 are electrically connected to the chip 1 through the transfer conductive elements 33. With this arrangement, the electrical connection assembly 100 of the present disclosure shortens the conductive path, reduces losses, and helps improve the quality of signal transmission. Besides, the electrical connection assembly 100 of the present disclosure can omit a printed circuit board, thereby improving the flexibility of component arrangement and saving costs.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. An electrical connection assembly, comprising:
a connection module, the connection module comprising a housing and a plurality of conductive elements, the housing comprising a mounting wall, and the conductive elements being exposed to the mounting wall;
a conductive film, the conductive film comprising a skeleton, an elastomer fixed to the skeleton and a plurality of transfer conductive elements embedded in the elastomer; and
a chip, the chip comprising a plurality of conductive portions;
wherein the conductive film is sandwiched between the mounting wall and the chip; the conductive elements are electrically connected to the conductive portions of the chip through the transfer conductive elements.

2. The electrical connection assembly according to claim 1, wherein each conductive element comprises a non-elastic first contact portion; the conductive elements comprise a first signal conductive terminal and a second signal conductive terminal;
each transfer conductive element comprises a transfer contact portion; the transfer conductive elements comprise a first transfer terminal and a second transfer terminal;
the conductive portions comprise a first conductive portion and a second conductive portion;
wherein the first transfer terminal is connected between the first signal conductive terminal and the first conductive portion, and the second transfer terminal is connected between the second signal conductive terminal and the second conductive portion.

3. The electrical connection assembly according to claim 2, wherein the first signal conductive terminal and the second signal conductive terminal form a first signal differential pair.

4. The electrical connection assembly according to claim 3, wherein the conductive elements further comprise a first ground conductive terminal and a second ground conductive terminal; and the first ground conductive terminal and the second ground conductive terminal are located on two sides of the first signal differential pair, respectively.

5. The electrical connection assembly according to claim 4, wherein the connection module comprises a first metal shielding piece and a second metal shielding piece;
the first metal shielding piece comprises a first abutting portion, a second abutting portion, and a first raised portion connected between the first abutting portion and the second abutting portion;
the second metal shielding piece comprises a third abutting portion, a fourth abutting portion, and a second raised portion connected between the third abutting portion and the fourth abutting portion; the first raised portion and the second raised portion have opposite raised directions;
the first abutting portion and the third abutting portion are in contact with two opposite side surfaces of the first ground conductive terminal, respectively; the second abutting portion and the fourth abutting portion are in contact with two opposite side surfaces of the second ground conductive terminal, respectively; the first abutting portion, the first raised portion, the second abutting portion, the second ground conductive terminal, the fourth abutting portion, the second raised portion, the third abutting portion and the first ground conductive terminal together form a shielding cavity in which the first signal conductive terminal and the second signal conductive terminal reside.

6. The electrical connection assembly according to claim 5, wherein the shielding cavity is exposed to the mounting wall.

7. The electrical connection assembly according to claim 5, wherein the connection module comprises a first insulating block formed on the first signal conductive terminal, the second signal conductive terminal, the first ground conductive terminal and the second ground conductive terminal; the first insulating block comprises a first protruding post provided on one side thereof, and a second protruding post provided on another side thereof;
the first raised portion defines a first positioning hole to receive the first protruding post; the second raised portion defines a second positioning hole to receive the second protruding post.

8. The electrical connection assembly according to claim 7, wherein the connection module comprises a cable connected to the first signal conductive terminal and the second signal conductive terminal;
the connection module further comprises a second insulating block formed on the first metal shielding piece, the second metal shielding piece, the first insulating block and the cable.

9. The electrical connection assembly according to claim 1, wherein the mounting wall comprises a mating surface beyond which the conductive elements extend;
the mounting wall further comprises at least one positioning post; the skeleton of the conductive film defines at least one first positioning through hole; the at least one positioning post passes through the first positioning through hole and extends out of the skeleton.

10. The electrical connection assembly according to claim 1, wherein the mounting wall comprises a mating surface, and the conductive elements extend beyond the mating surface;
the mounting wall further comprises a plurality of positioning portions protruding beyond the mating surface; the positioning portions are located at four corners of the mounting wall;
the positioning portions lock outer edges of the skeleton.

11. The electrical connection assembly according to claim 1, wherein the mounting wall comprises a mating surface, and the conductive elements extend beyond the mating surface;
the mounting wall further comprises a plurality of positioning portions protruding beyond the mating surface; the positioning portions form an accommodation space; the mating surface is exposed to the accommodation space; the chip is at least partially accommodated in the accommodation space.

12. The electrical connection assembly according to claim 1, further comprising a retaining cover; the retaining cover being mounted to the housing to retain the chip between the mounting wall and the retaining cover.

13. The electrical connection assembly according to claim 12, wherein the retaining cover defines a receiving groove and an opening that extends through the retaining cover and communicates with the receiving groove; the chip is at least partially received in the receiving groove and exposed in the opening.

14. The electrical connection assembly according to claim 12, further comprising a fastener passing through the retaining cover to secure the retaining cover to the mounting wall.

15. An electrical connection assembly, comprising:
a connection module, the connection module comprising a housing and a plurality of conductive elements, the housing comprising a mounting wall having a mating surface, each conductive element comprising a rigid first contact portion extending beyond the mating surface;
a conductive film, the conductive film comprising an elastomer and a plurality of transfer conductive elements fixed in the elastomer; the rigid first contact portions being in contact with the transfer conductive elements;
a chip, the chip comprising a plurality of conductive portions; the transfer conductive elements being in contact with the conductive portions; and
a retaining cover, the retaining cover being mounted to the housing to retain the chip between the mounting wall and the retaining cover;
wherein the conductive film is sandwiched between the mounting wall and the chip; the conductive elements are electrically connected to the conductive portions of the chip through the transfer conductive elements.

16. The electrical connection assembly according to claim 15, wherein the conductive elements comprise a first signal conductive terminal and a second signal conductive terminal;
each transfer conductive element comprises a rigid transfer contact portion; the transfer conductive elements comprise a first transfer terminal and a second transfer terminal;
the conductive portions comprise a rigid first conductive portion and a rigid second conductive portion;
wherein the first transfer terminal is connected between the first signal conductive terminal and the first conductive portion, and the second transfer terminal is connected between the second signal conductive terminal and the second conductive portion.

17. The electrical connection assembly according to claim 16, wherein the first signal conductive terminal and the second signal conductive terminal form a first signal differential pair;
wherein the conductive elements further comprise a first ground conductive terminal and a second ground conductive terminal; and the first ground conductive terminal and the second ground conductive terminal are located on two sides of the first signal differential pair, respectively; and
wherein the connection module comprises a first metal shielding piece and a second metal shielding piece;
the first metal shielding piece comprises a first abutting portion, a second abutting portion, and a first raised portion connected between the first abutting portion and the second abutting portion;
the second metal shielding piece comprises a third abutting portion, a fourth abutting portion, and a second raised portion connected between the third abutting portion and the fourth abutting portion; the first raised portion and the second raised portion have opposite raised directions;
the first abutting portion and the third abutting portion are in contact with two opposite side surfaces of the first ground conductive terminal, respectively; the second abutting portion and the fourth abutting portion are in contact with two opposite side surfaces of the second ground conductive terminal, respectively; the first abutting portion, the first raised portion, the second abutting portion, the second ground conductive terminal, the fourth abutting portion, the second raised portion, the third abutting portion and the first ground conductive terminal together form a shielding cavity in which the first signal conductive terminal and the second signal conductive terminal reside.

18. The electrical connection assembly according to claim 17, wherein the connection module comprises a first insulating block formed on the first signal conductive terminal, the second signal conductive terminal, the first ground conductive terminal and the second ground conductive terminal; the first insulating block comprises a first protruding post provided on one side thereof, and a second protruding post provided on another side thereof;
the first raised portion defines a first positioning hole to receive the first protruding post; the second raised portion defines a second positioning hole to receive the second protruding post.

19. The electrical connection assembly according to claim 18, wherein the connection module comprises a cable connected to the first signal conductive terminal and the second signal conductive terminal;
the connection module further comprises a second insulating block formed on the first metal shielding piece, the second metal shielding piece, the first insulating block and the cable.

20. The electrical connection assembly according to claim 15, wherein the retaining cover defines a receiving groove and an opening that extends through the retaining cover and communicates with the receiving groove; the chip is at least partially received in the receiving groove and exposed in the opening.
